(19) United States
(12) Patent Application Publication
(10) Pub. No.: US 2002/0118874 A1
(43) Pub. Date: Aug. 29, 2002

(54) Apparatus and method for taking dimensions of 3D object

(76) Inventors: Yun-Su Chung, Taejon (KR); Hea-Won Lee, Taejon (KR); Jin-Seog Kim, Taejon (KR); Hye-Kyu Kim, Seoul (KR); Chee-Hang Park, Taejon (KR); Kil-Houm Park, Taegu (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/974,494

(22) Filed: Oct. 9, 2001

(30) Foreign Application Priority Data
Dec. 27, 2000 (KR) 2000-83256

(51) Int. Cl. G06K 9/48

(52) U.S. Cl. 382/154; 382/199

(57) ABSTRACT

The present invention relates to an apparatus and method for real-time automatically taking the length, width and height of a rectangular object that is moved on a conveyor belt. The method of taking the dimensions of a 3D object, the method comprising the steps of: a) obtaining an object image having the 3D object; b) detecting all edges within a region of interest of the 3D object; c) extracting line segments from the edges of the 3D object and then extracting features of the 3D object from the line segments; and d) generating 3D models based on the features of the 3D object and taking the dimensions of the 3D object from the 3D models.

### FIELD OF THE INVENTION

The present invention generally relates to an apparatus and method for taking the dimensions of a 3D rectangular moving object; and, more particularly, to an apparatus for taking the dimensions of the 3D rectangular moving object in which a 3D object is sensed, an image of the 3D object is captured and features of the object are then extracted to take the dimensions of the 3D object, using an image processing technology.

### DESCRIPTION OF THE PRIOR ART

Traditional methods of taking the dimensions include a manual method using a tape measure, etc. However, as this method is used for an object not moving, it is disadvantageous to apply this method to an object on a moving conveyor environment.

In U.S. Pat. No. 5,991,041, Mark R. Woodworth describes a method of taking the dimensions using a light curtain for taking the height of an object and two laser range finders for taking the right and left sides of the object. In the method, as the object of a rectangular shape is conveyed, values taken by respective sensors are reconstructed to take the length, width and height of the object. This method is advantageous in taking the dimensions of a moving object such as an object on the conveyor. However, there is a problem that it is difficult to take the dimensions of the still object.

In U.S. Pat. No. 5,661,561 issued to Albert Wurz, John E. Romaine and David L. Martin, it is used a scanned, triangulated CCD (charge coupled device) camera/laser diode combination to capture the height profile of an object when it passes through this system. This system that loaded dual DSP (digital signal processing) processor board, then calculates the length, width, height, volume and position of the object (or package) based on this data. This method belongs to a transitional stage in which a laser-based dimensioning technology moves to a camera-based dimensioning technology. But there are disadvantages that this system united with the laser technology has the difficulties of hardware embodiment.

U.S. Pat. No. 5,719,678 issued to Reynolds et al. discloses a method for automatically determining the volume of an object. This volume measurement system includes a height sensor and a width sensor positioned in generally orthogonal relationship. Therein, CCD sensors are employed as the height sensor and the width sensor. Of course, the mentioned height sensor can adopt a laser sensor to measure the height of the object.

U.S. Pat. No. 5,854,679 is concerned with a technology using only cameras, which employs plane images obtained from the top of the conveyor and lateral images obtained from the side of the conveyor belt. As a result, these systems employ a parallel processing system in which individual cameras are each connected to independent systems in order to take the dimensions at rapid speed and high accuracy. However, there are disadvantages that the scale of the system and the cost for the embodiment of the system increase.

### SUMMARY OF THE INVENTION

Therefore, it is a purpose of the present invention to provide an apparatus and method for taking dimensions of a 3D object in which the dimensions of a still object as well as a moving object on a conveyor can be taken.

In accordance with an aspect of the present invention, there is provided an apparatus for taking dimensions of a 3D object, comprising: an image input device for obtaining an object image having the 3D object; an image processing device for detecting all edges within a region of interest of the 3D object based on the object image obtained in said image input device; a feature extracting device for extracting line segments of the 3D object and features of the object from the line segments based on the edges detected in said image processing device; and a dimensioning device for generating 3D models using the features of the 3D object and for taking the dimensions of the 3D object from the 3D models.

In accordance with another aspect of the present invention, there is provided a method of taking dimensions of a 3D object, the method comprising the steps of: a) obtaining an object image having the 3D object; b) detecting all edges within a region of interest of the 3D object; c) extracting line segments from the edges of the 3D object and then extracting features of the 3D object from the line segments; and d) generating 3D models based on the features of the 3D object and taking the dimensions of the 3D object from the 3D models.

In accordance with further another aspect of the present invention, there is provided a computer-readable recording medium storing instructions for executing a method of taking dimensions of a 3D object, the method comprising the steps of: a) obtaining an object image having the 3D object; b) detecting all edges within a region of interest of the 3D object; c) extracting line segments from the edges of the 3D object and then extracting features of the 3D object from the line segments; and d) generating 3D models based on the features of the 3D object and taking the dimensions of the 3D object from the 3D models.

### BRIEF DESCRIPTION OF THE INVENTION

Other objects and aspects of the invention will become apparent from the following description of the embodiments with reference to the accompanying drawings, in which:

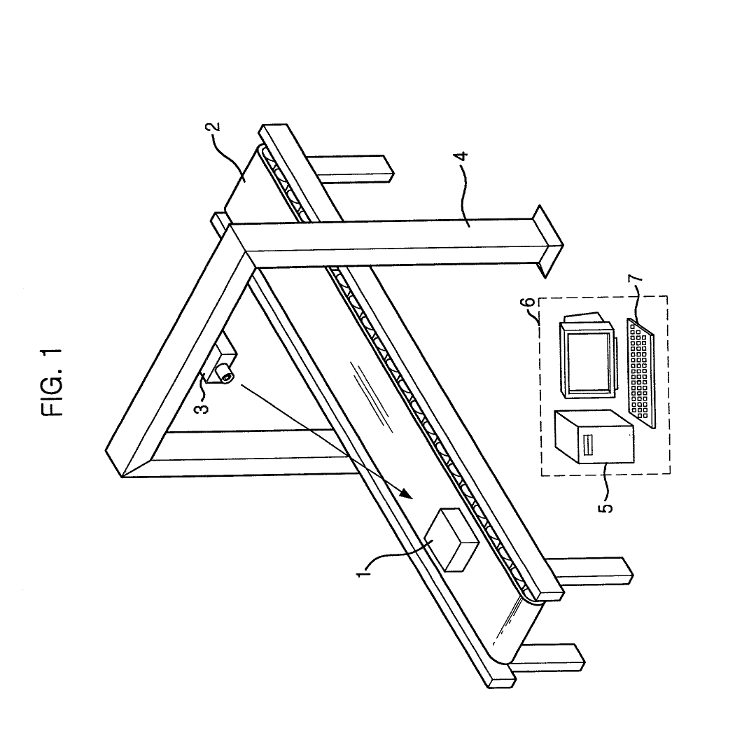

FIG. 1 illustrates a system for taking the dimensions of a 3D moving object applied to the present invention;

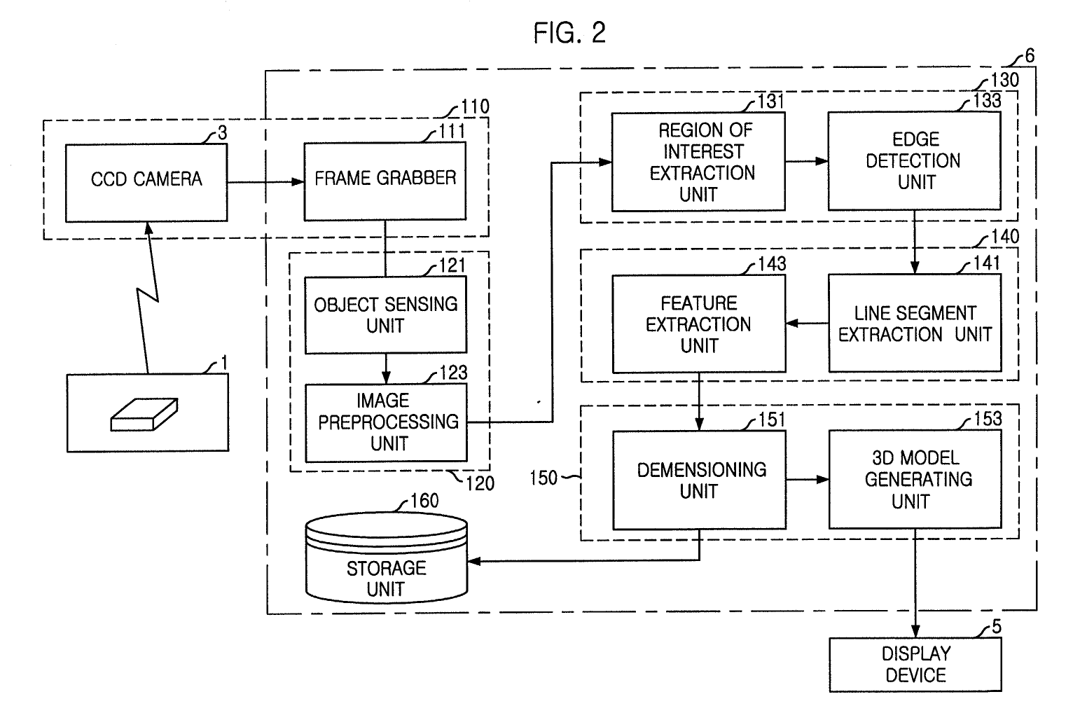

FIG. 2 is a block diagram of a dimensioning apparatus for taking the dimensions of 3D moving object based on a single CCD camera according to the present invention;

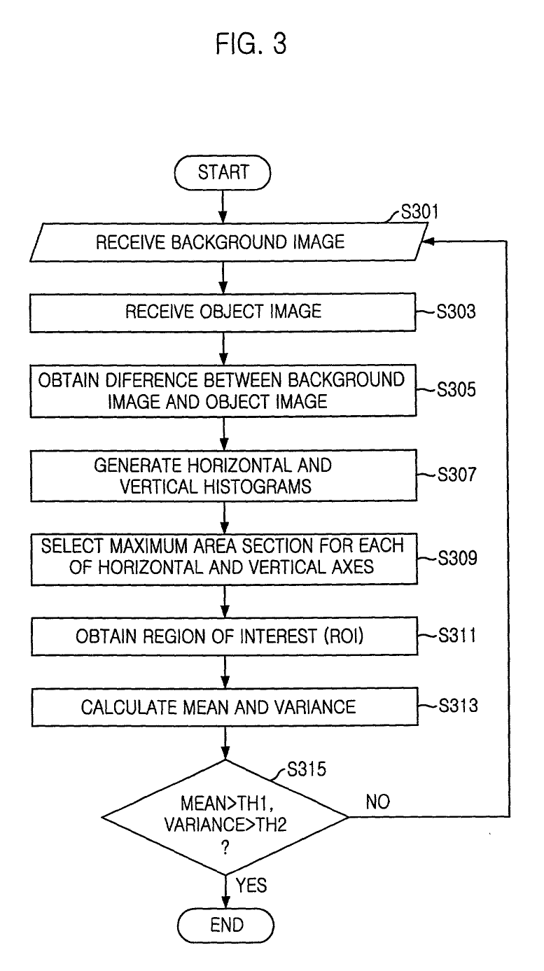

FIG. 3 is a flow chart illustrating a method of extracting a region of interest (ROI) in a region of interest extraction unit and in an object sensing unit;

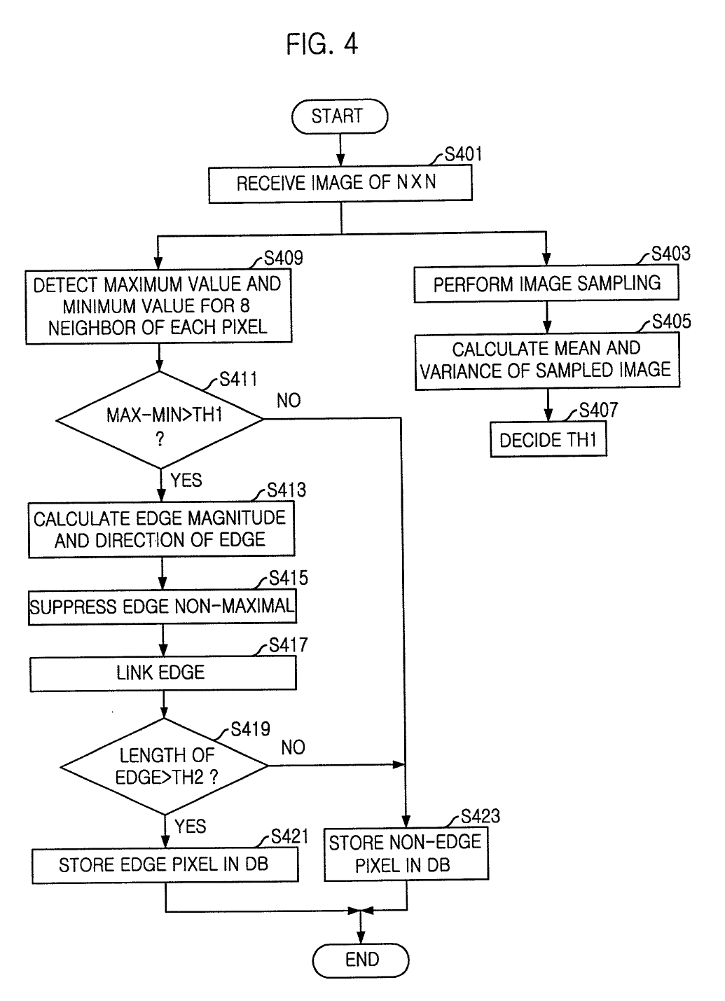

FIG. 4 is a flowchart illustrating a method of detecting an edge in an edge detecting unit of the image processing device;

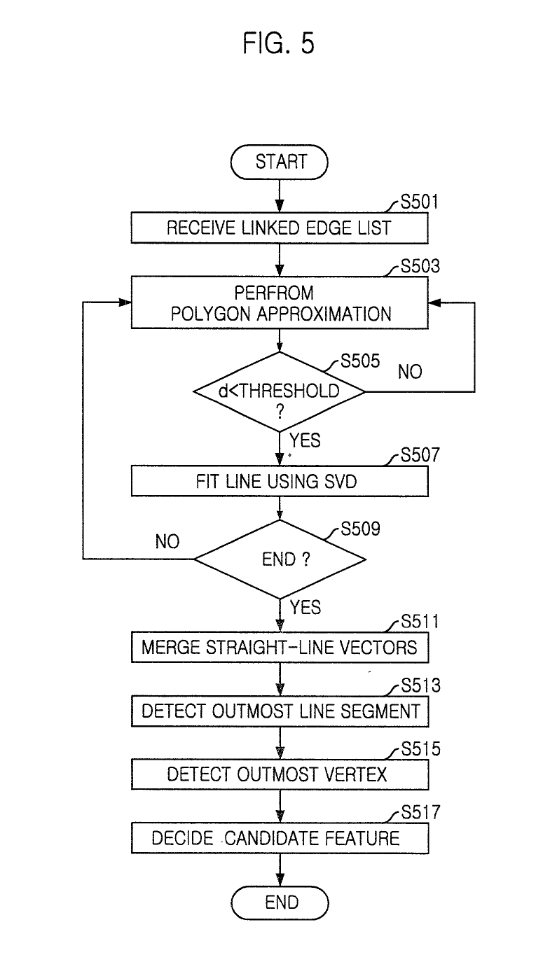

FIG. 5 is a flowchart illustrating a method of extracting line segments in a line segments extraction unit and a method of extracting features in a feature extraction unit;

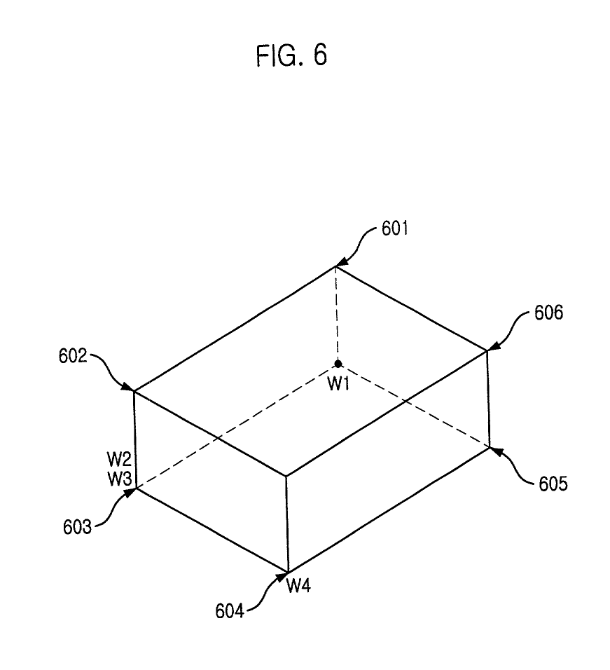

FIG. 6 is a diagram of an example of the captured 3D object;

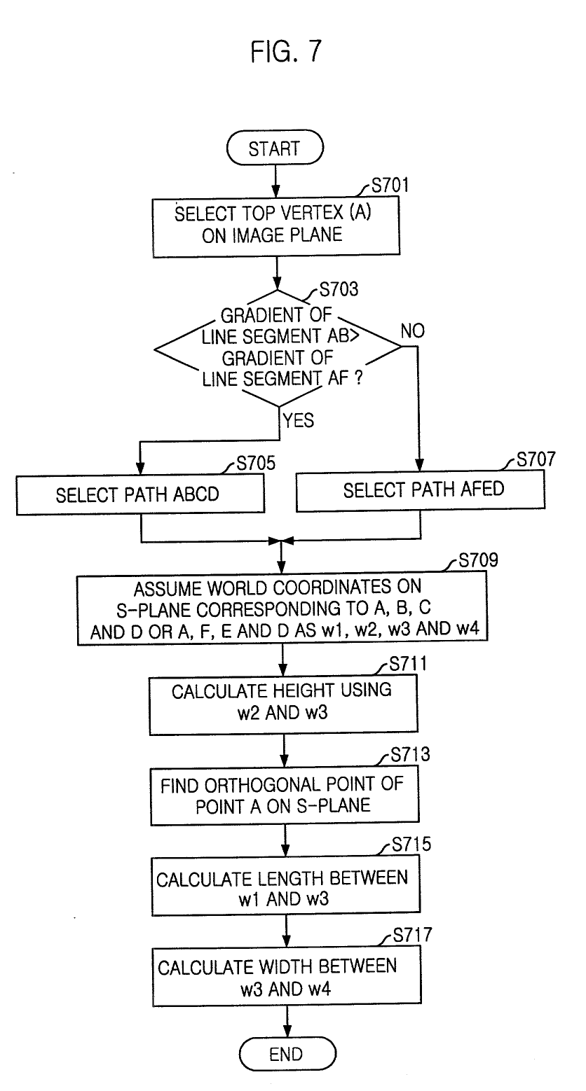

FIG. 7 is a flow chart illustrating a process of taking the dimensions in a dimensioning device; and

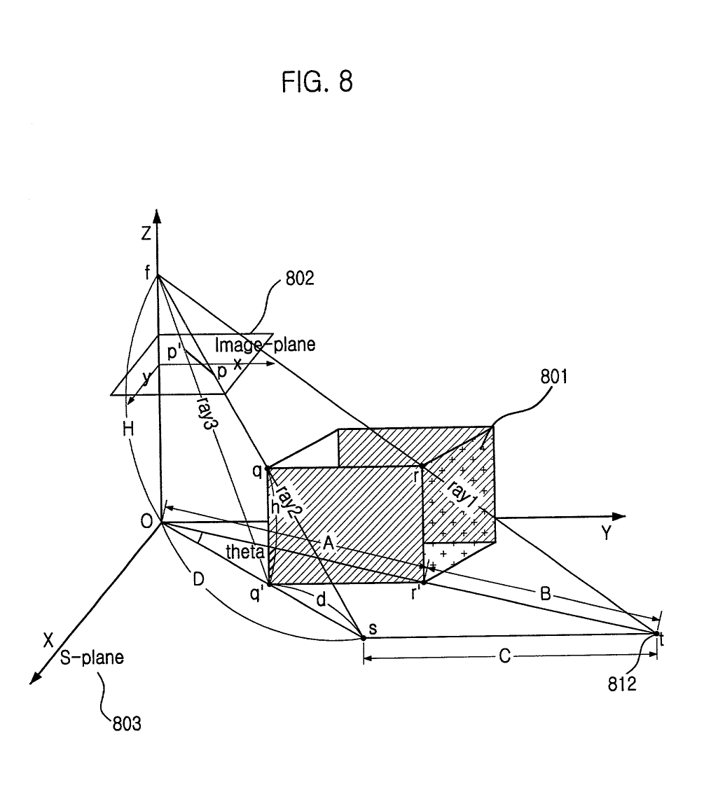

FIG. 8 shows geometrically the relationship in which points of 3D object are mapped on two-dimensional images via a ray of a camera.

### PREFERRED EMBODIMENT OF THE INVENTION

Hereinafter, the present invention will be described in detail with reference to accompanying drawings, in which the same reference numerals are used to identify the same element.

Referring to FIG. 1, a system for taking the dimensions of 3D moving object includes a conveyor belt 2 for moving the 3D rectangular object 1, a camera 3 installed over the conveyor belt 2 for taking an image of the 3D rectangular object 1, a device 4 for supporting the camera 3 and a dimensioning apparatus 5 which is coupled to the camera 3 and includes an input/output device, e.g., a monitor 6 and a keyboard 7.

FIG. 2 illustrates a dimensioning apparatus for taking the dimensions of a 3D moving object based on a single CCD camera according to the present invention,

Referring to FIG. 2, the dimensioning apparatus according to the present invention includes an image input device 110 for capturing an image of a desired 3D object, an object sensing device 120 for sensing the 3D object through the image inputted via the image input device 110 to perform an image preprocessing, an image processing device 130 for extracting a region of interest (ROI) and detecting the edges, and a feature extracting device 140 for extracting line segments and the image within the regions of interest (ROI), a dimensioning device 150 for calculating the dimensions of the object based on the result of the image processing device and generating a 3D model of the object, and storage device 160 for storing the result of the dimensioning device. Then, the 3D model of the generated object is displayed on the monitor 5.

The image input device 110 includes the camera 3 and a frame grabber 111. Also, the image input device may further include at least an assistant camera. The camera 3 may include XC-7500 progressive CCD camera having the resolution of 758×582 and capable of producing a gray value of 256, manufactured by Sony Co., Ltd. (Japan). The image is converted into digital data by a frame grabber 111, e.g., MATROX METEOR II type. At this time, parameters of the image may be extracted using MATROX MIL32 Library under Window98 environment.

The object sensing device 120 compares an object image obtained by the image input device 110 with a background image. The object sensing device 120 includes an object sensing unit 121 and an image preprocessing unit 123 for performing a preprocessing operation for the image of the sensed object.

The image processing device 130 includes a region of interest (ROI) extraction unit 131 for extracting 3D object regions, and an edge detection unit 133 for extracting all the edges within the located region of interest (ROI).

The feature extracting device 140 includes a line segment extraction unit 141 for extracting line segments from the result of detecting the edges and a feature extraction unit 143 for extracting features (or vertexes) of the object from the outmost intersection of the extracted line segments.

The dimensioning device 150 includes a dimensioning unit 151 for obtaining a world coordinate on the two-dimensional plane and the height of the object from the features of the 3D object obtained from the image to calculate the dimensions of the object, and a 3D model generating unit 153 for modeling the 3D shape of the object from the obtained world coordinate.

A method of taking the dimensions of the 3D object in the system for taking the dimensions of 3D moving object will be now explained.

The image input device 110 performs an image capture for the 3D rectangular object 1. The 3D object 1 is conveyed by means of a conveyor (now shown). At this time, the image input device 11 continuously captures images and then transmits the image obtained by the object sensing device 120 to the image processing device 130.

The object sensing device 120 continuously receives images from the image input device 110 and then determines whether there exists an object. If the object sensing unit 121 determines whether there is an object, the image preprocessing unit 123 performs noise reduction of the object. If there is no object, the image preprocessing unit 123 does not operate but transmits a control signal to the image input device 110 to repeatedly perform an image capture process.

The image processing device 130 compares the object image from the image obtained by the image input device 110 with the background image to extract a region of a 3D object and to detect all the edges within the located region of interest (ROI).

At this time, locating the object region is performed by a method of comparing the previously stored background image and an image including an object.

The edge detection unit 133 in the image processing device 130 performs an edge detection process based on statistic characteristics of the image. The edge detection method using the statistic characteristics can perform edge detection that is insensitive to variations of external illuminations. In order to rapidly extract the edge, candidate edge pixels are estimated, and the size and direction of the edge are determined for the estimated edge pixels.

The feature extracting device 140 extracts line segments of the 3D object and then extracts features of the object from the line segments.

FIG. 3 is a flow chart illustrating a method of extracting a region of interest (ROI) extraction unit 131 and sensing an object in an object sensing unit 121.

Referring now to FIG. 3, first, a difference image between the image including the object obtained in the image input device 110 and the background image is obtained at steps S301, S303 and S305. Then, a projection histogram is generated for each of a horizontal axis and a vertical axis of the obtained difference image at step S307. Next, a maximum area section for each of the horizontal axis and the vertical axis is obtained from the generated projection histogram at step S309. Finally, a region of interest (ROI), being an intersection region, is obtained from the maximum area section of each of the horizontal axis and the vertical axis at step S311. After the region of interest (ROI) is obtained, in order to determine whether there is any object, the average and variance values within the region of interest (ROI) are calculated at step S313. Finally, as the results of the determination, if there is an object, i.e., the mean value is larger than a first threshold and the variance value is larger than a second threshold, the located region of interest (ROI) is used as an input to the image processing device 130. If not, the object sensing unit 121 continuously extracts the region of interest (ROI).

FIG. 4 is a flow chart illustrating a method of detecting an edge in the edge detection unit 133 of the image processing device 130.

Referring to FIG. 4, the method of detecting an edge roughly includes a step of extracting statistical characteristics of an image for determining the threshold value, a step of determining candidate edge pixels and edge detection pixels and a step of connecting the detected edge pixels to remove edge pixels having a short length.

In more detail, if an image of N×N size is first inputted at step S401, the image is sampled by a specific number of pixels at step S403. Then, an average value and a variance value of the sampled pixels are calculated at step S405 and the average value and variance value of the sampled pixels are then set to a statistical feature of a current image. A threshold value Th1 is determined based on statistical characteristics of the image at step S407.

Meanwhile, if the statistical characteristics of the image is determined, candidate edge pixels for all the pixels of the inputted image are determined. For this, the maximum value and the minimum value among the values between eight pixels neighboring to the current pixel x are detected at step S409. Then, the difference between the maximum value and the minimum value is compared with the threshold value (Th1) at step S411. The threshold value (Th1) is set based on the statistical characteristics of the image, as mentioned above.

As a result of the determination in the step S411, if the difference value between the maximum value and the minimum value is greater than the threshold value (Th1), it is determined that a corresponding pixel is an edge pixel and a process proceeds to step S413. Meanwhile, if the difference value between the maximum value and the minimum value is smaller than the threshold value (Th1), i.e., a corresponding pixel is a non-edge pixel, and then stored in the database.

If the corresponding pixel is a candidate edge pixel, the size and direction of the edge is determined using a sobel operator [Reference: ‘Machine Vision’ by Ramesh Jain] at step S413. In the step S413, the direction of the edge is represented using a gray level similarity code (GLSC).

After the direction of the edge is represented, edges having a different direction from neighboring edges among these determined edges are removed at step S415. This process is called an edge non-maximal suppression process. At this time, an edge lookup table is used. Finally, remaining candidate edge pixels are determined at step S417. Then, if the connected length is greater than the threshold value Th2 at step S419, an edge pixel is finally determined and is then stored in the edge pixel database. On the contrary, if the linked length is smaller than the threshold value Th2, it is determined to be a non-edge pixel, which is then stored in the non-edge pixel database. The images having pixels determined as the edge pixels by this method are images representing an edge portion of an object or a background.

After the edge of the 3D object is detected, the edge will have the thickness of one pixel. Line segment vectors are extracted in the line segment extraction unit 141 and features for taking the dimensions from the extracted line segments are also extracted in the feature extraction unit 141.

FIG. 5 is a flow chart illustrating a process of extracting line segments in the line segment extraction unit 141 and a process of extracting features in the feature extraction unit 143.

Referring to FIG. 5, if a set of edge pixels of the 3D object obtained in the image processing device 130 is inputted at step S501, the set of edge pixels are divided into a lot of straight-line vectors. At this time, the set of the linked edge pixels are divided into straight-line vectors using a polygon approximation at step S503. Line segments in thus divided straight vectors are fixed using singular value decomposition (SVD) at step S507. The polygon approximation and the SVD are described in an article ‘Machine Vision’ by Ramesh Jain, Rangachar Kasturi and Brian G. Schunck, pp.194-199, 1995, which they are not subject matter in the present invention and detailed description of them will be skipped. After the above procedures are performed for all the list of edges at step S509, the extracted straight-line vectors are recombined in separate neighboring straight-lines at step S511.

If line segments thus constituting the 3D object are extracted, the feature extraction unit 143 performs a feature extraction process. After the outermost line segment of the object is found from the extracted line segments at step S513, the outermost vertex between the outermost line segments is detected at step S515. Thus, the outermost vertexes are determined to be candidate features at step S517. Through these processes of extracting features, damage and blurring effect due to distortion of shape of the 3D object image can be compensated for.

Next, the dimensioning device 150 takes the dimensions of a corresponding object from the feature extracting device 140. A process of taking the dimensions in a dimensioning device will be described with reference to FIGS. 6 and 7.

FIG. 6 is a diagram of an example of the captured 3D object on a 2D image.

Referring to FIG. 6, reference numerals 601 to 606 denote outermost vertexes of the captured 3D object, respectively, the point 601 is a point that the value of the x coordinate on the image has the smallest value and the point 604 is a point that the value of the x coordinate on the image has the greatest value.

FIG. 7 is a flow chart illustrating a process of taking the dimensions in a dimensioning device.

First, among the outermost vertexes 601 to 606 of the object obtained in the feature extraction device, the point 601 having the smallest x coordinate value is selected at step S701. Then, the inclinations between neighboring vertexes are compared at step S703 to select a path including both the point 601 and the greater inclination. That is, if the inclination between the points 601 and 602 is larger than the inclination between the points 601 and 606 in the 3D object, a path made by 601, 602, 603 and 604 are selected at step S705. On the contrary, if the inclination between two points 601 and 602 is smaller than the inclination between two points 601 and 606, another path made by 601, 606, 605 and 604 is selected. Next, assuming that the points on the bottom place corresponding to the points 601, 602, 603 and 604 are w1, w2, w3 and w4. If a path made by 601, 602, 603 and 604 are selected, the point 603 is like w3 and the point 604 is like w4. The world coordinates of two points 603 and 604 may be obtained using a calibration matrix. For example, a Tsai'method may be used for the calibration. Tsai'method is described in more detail in an article by R. Y. Tsai, “A versatile camera calibration technique for high-accuracy 3D machine vision metrology using off-the-shelf camera and lenses”, IEEE Trans. Robotics and Automation, 3(4), August 1987. Through the process of this calibration, one-to-one mapping is performed between a world coordinate on the plane on which the object is located, and an image coordinate. Also, x and y of w2 is like the value of w3. Therefore, the world coordinates of w2 can be obtained by calculating the height between w2 and w3. After the coordinate of w2 is obtained, an orthogonal point w1 between the point A and the bottom plane is obtained. Finally, the length of the object is determined by w1 and w3. The width of the 3D object can be obtained by obtaining the length between w3 and w4.

FIG. 8 shows the basic model for the projection of points in the scene with 3D object 801, onto the image plane. In FIG. 8, a point f is a position of a camera and a point O is the origin of the world coordinate system. As two points q and s on the world coordinate system (WCS) exist on the same ray 2, two points q and s are projected onto the same point p on the image plane 802. Given the real world coordinates on S-plane 803, where 3D object is put, and the height H of the camera and the origin of the world coordinate system, we can determine the height h of the object between two points q on the ray 2 and q′ on S-plane 703, by the following method.

Referring to FIG. 8, three points O, f and s make a triangle, and another three points q, q′ and s make another triangle. The ratio of the corresponding sides of two triangles must be the same, because these two triangles are similar. The height of the object can therefore be calculated by the following equation (1).

$$h = \frac{dH}{D} \qquad ( 1 )$$

where H is a height from the point O to the position of the camera f, D is a length from the point O to the point s, and d is a length from the point q′ to the point s.

Also, the equation (1) can be transferred into the following equation (2).

$$d = \frac{hD}{H} \qquad ( 2 )$$

Unlike height, the width and the length of the object can directly be calculated by using calibrated points on S-plane. Especially, when the camera could take a look at the sides that have the width and the length of the object, the above methods including two equations are so effective. However we can suppose the case that the camera can't directly take a look at the side, which have the length of the object. In this case, the other methods or equations are needed and should be derived. Like examples of equations (1) and (2), the points on the S-plane are used. Referring to FIG. 8, the first triangle made by three points O, s, and t are similar to the second triangle made by three points O, q′ and r′. Using the trigonometric relationship, the theta made by the triangle tOs, can be calculated by the following equation (3).

$$θ = {sin}^{- 1} ( \frac{{( A + B )}^{2} + {D}^{2} - {C}^{2}}{2 ( A + B ) D} ) \qquad ( 3 )$$

Also, with this theta, the length between two points q′ and r′ is determined by the following equation (4).

\overline{q′r′}=\sqrt{A²+(D*d)²−2A(D−d) cos θ} (4)

As mentioned above, in the present invention, a single CCD camera is used to sense the 3D object and to take the dimensions of the object, and additional sensors are not necessary for sensing the object. Therefore, the present invention can be applied to sense both of the moving object and the still object. The present invention could not only reduce the cost necessary for system installation but also the size of the system.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for taking dimensions of a 3D object, comprising:
an image input means for obtaining an object image having the 3D object;
an image processing means for detecting all edges within a region of interest of the 3D object based on the object image obtained in said image input means;
a feature extracting means for extracting line segments of the 3D object and features of the object from the line segments based on the edges detected in said image processing means; and
a dimensioning means for generating 3D models using the features of the 3D object and for taking the dimensions of the 3D object from the 3D models.

2. The apparatus as recited in claim 1, further comprising a dimension storage means for storing the dimensions of the object.

3. The apparatus as recited in claim 1, wherein said image input means includes:
an image capture unit for capturing the object image; and
an object sensing unit for sensing whether the 3D object to be proceeded or not.

4. The apparatus as recited in claim 3, wherein said image input means further includes an image preprocessor for equalizing the object image obtained by said image capture unit to remove noise from the object image.

5. The apparatus as recited in claim 3, wherein said object sensing unit is an image sensor.

6. The apparatus as recited in claim 3, wherein said object sensing unit is a laser sensor.

7. The apparatus as recited in claim 3, wherein said image capture unit is a CCD camera.

8. The apparatus as recited in claim 7, wherein said image capture unit further includes at least an assistant camera.

9. The apparatus as recited in claim 1, wherein said image processing means includes:
a region of interest (ROI) extraction unit for comparing a background image and the object image, and extracting a region of the 3D object; and
an edge detecting unit for detecting all the edges within the region of the 3D object extracted by said ROI extraction unit;

10. The apparatus as recited in claim 1, wherein said feature extracting means includes:
a line segment extraction unit for extracting line segments from all the edges detected by said image processing means; and
a feature extraction unit for finding an outermost intersecting point of the line segments and extracting features of the 3D object.

11. The apparatus as recited in claim 1, wherein said dimensioning means includes:
a 3D model generating unit for generating a 3D model of the 3D object from the features of the 3D object obtained from the object image; and
a dimensions calculating unit for calculating a length, a width and a height of the 3D model and calculating the dimensions of the 3D object.

12. A method of taking dimensions of a 3D object, comprising the steps of:
a) obtaining an object image having the 3D object;
b) detecting all edges within a region of interest of the 3D object;
c) extracting line segments from the edges of the 3D object and then extracting features of the 3D object from the line segments; and
d) generating 3D models based on the features of the 3D object and taking the dimensions of the 3D object from the 3D models.

13. The method as recited in claim 12, further comprising the step of d) storing the dimensions of the 3D object taken in said step c).

14. The method as recited in claim 12, wherein said step a) includes the steps of:
a1) capturing the object image of the 3D object; and
a2) sensing whether an object is included in the object image.

15. The method as recited in claim 14, wherein said step a) further includes the step of a3) equalizing the object image to remove noise from the object image.

16. The method as recited in claim 15, wherein the step a3) is performed by an image sensor.

17. T he method as recited in claim 15, wherein the step a3) is performed by a laser sensor.

18. The method as recited in claim 12, wherein said step b) includes
b1) comparing a background image and the object image and then extracting a region of the 3D object; and
b2) detecting all the edges within the region of the 3D object.

19. The method as recited in claim 12, wherein said step c) includes:
c1) extracting a straight-line vector from all the edges; and
c2) finding an outermost intersecting point of the line segments and extracting the features.

20. The method as recited in claim 18, wherein said step b2) includes:
b2-1) sampling an input N×N image of the object image and then calculating an average and variance of the sampled image to obtain a statistical feature of the object image, generating a first threshold;
b2-2) extracting candidate edge pixels of which brightness is rapidly changed, among all the pixels of the input N×N image;
b2-3) connecting the candidate edge pixels extracted in to neighboring candidate pixels; and
b2-4) storing the candidate edge pixels as final edge pixels if the connected length is greater than a second threshold and storing the candidate edge pixels as non-edge pixels if the connected length is smaller than the threshold.

21. The method as recited in claim 20, wherein said step b2-2) includes the steps of:
b2-2-1) detecting a maximum value and a minimum value among difference values between a current pixel (x) and eight neighboring pixels; and
b2-2-2) classifying the current pixel as a non-edge pixel if the difference value between the maximum value and the minimum value is smaller than the first threshold, and classifying the current pixel as a candidate edge pixel if the difference value between the maximum value and the minimum value is greater than the first threshold.

22. The method as recited in claim 21, wherein said step b2-3) includes the steps of:
b2-3-1) detecting a size and a direction of the edge by applying a sobel operator to said candidate edge pixel; and
b2-3-2) classifying the candidate edge pixel as a non-edge pixel and connecting remaining candidate edge pixels to the neighboring candidate edge pixels, if the size of the candidate edge pixel of which the size and direction are determined is smaller than other candidate edge pixels.

23. The method as recited in claim 19, wherein said step cl) includes the steps of:
c1-1) splitting all the edge pixels detected in said step b); and
c1-2) respectively classifying the divided straight-line vectors depending on the angle to recombine the vector with neighboring straight-line vectors.

24. The method as recited in claim 23, wherein said step b3-1) uses a polygonal approximation method to divide said edge pixels lists into straight-line vectors.

25. The method as recited in claim 12, wherein said step d) includes the steps of:
d1) generating a 3D model of the 3D object from the features of the 3D object; and
d2) calculating a length, a width and a height of the 3D model to calculate the dimensions of the 3D object.

26. The method as recited in claim 25, wherein said step c1) includes the steps of:
d1-1) selecting major features necessary to generate a 3D model among the features of the 3D object; and
d1-2) recognizing world coordinate points using the selected features.

27. The method as recited in claim 26, wherein said step d1-1) includes the step of: selecting a top feature and a lowest feature among the features of the 3D object by using the inclination between the top feature and its two neighboring features to select four features constituting a path to the lowest feature along the inclination.

28. The method as recited in claim 27, wherein a height of the object is calculated by an equation as:
$$h = \frac{dH}{D}$$
where H is a height from an origin O of a world coordinate to a position f of an image capture unit, D is a length from the origin O to a point s which is located on the same lay as a vertex of the object and projected onto the same point on an image plane, and d is a length from the point s to a point q′ located on an S-plane and being orthogonal to the point q.

29. The method as recited in claim 28, wherein an angle is calculated by an equation as:
$$θ = {sin}^{- 1} ( \frac{{( A + B )}^{2} + {D}^{2} - {C}^{2}}{2 ( A + B ) D} )$$
where A is a length from the origin O to the point r′, B is a length from the position f of the image capture unit and C is a length between points s and t.

30. The method as recited in claim 29, wherein a length between two points q′ and r′ is calculated by an equation as:
\overline{q′r′}=\sqrt{A²+(D*d)²−2A(D−d) cos θ}.

31. A computer-readable recording medium storing instructions for executing a method of taking dimensions of a 3D object, the method comprising the steps of:
a) obtaining an object image having the 3D object;
b) detecting all edges within a region of interest of the 3D object;
c) extracting line segments from the edges of the 3D object and then extracting features of the 3D object from the line segments; and
d) generating 3D models based on the features of the 3D object and taking the dimensions of the 3D object from the 3D models.
